(19) United States
(12) Patent Application Publication
(10) Pub. No.: US 2021/0039424 A1
(43) Pub. Date: Feb. 11, 2021

(54) 2 piece Holding Device

(71) Applicant: Melvin Lee Bartoo, Alturas, CA (US)

(72) Inventor: Melvin Lee Bartoo, Alturas, CA (US)

(21) Appl. No.: 16/873,709

(22) Filed: Jun. 8, 2020

Related U.S. Application Data
(60) Provisional application No. 62/921,321, filed on Jun. 12, 2019.

(51) Int. Cl. B42F 1/00

(52) U.S. Cl. CPC B42F 1/00; B42P 2241/04

(57) ABSTRACT

One or two piece plates can be any size
width, length, or thickness. And used for most any thing needing held together. The main purpose is to go around files or paper or folders so as to hold together. Were as to fit in file drawer
Were the holes allow wire straps or string to pass around files or folder ect. Made of steal. This works real easy. Can be made out other hard material
The more important use is to fit in file cabinets, to hold bundles of files together, and to hold unit of paper together. To do a job larger than a normal paper folder.
Made to fit around folders and still fit in file

### TECHNICAL FIELD

The Present disclosure relates in general, to Paper storing, filing folder, envelops books etc. Needing held together.

### BACK GROUND

The 1 and 2pc holding device is unlike Paper clips, paper binders, folders, book binders card board box and folding hangers and the like. Many binders and clips are made of wood, particle board, steal, copper brass aluminum and other metals, carbon fiber nylon plastic and other polymer etc.

Bent or sprung to hold paper, folder, pamphlets, etc.

this device uses fruition and compression in same manner

### SUMMARY

A one or 2 piece holding device using wire, fishing line, string, yarn elastic bands etc. May be made out of any hard material from card board to hardest metal, wood, steel, plastic, etc.

Having any number of holes, near its edges, so to allow string, wire, line, elastic band, etc. To squeeze or tie paper, folders, pamphlets, books, etc. Tight together. Whether 1 or 2pc.

Using any of many kinds of slip tie, tie slips, fasteners, wire tie, tri slide glide, slide glide, slide snaps, etc. So to hold or fasten or bind. Use tension and, or, compression to keep tight,

This invention seeks to provide a solution by providing away to handle or deal with (holding small quantities of folders), (small stacks of paper), (holding of folders in file), (separating small groups of books on a shelf), etc.

### BRIEF DESCRIPTION OF DRAWINGS

To assist those of skill in art in making and using the disclosed invention a and associated methods, reference is made to the accompany figures, wherein:

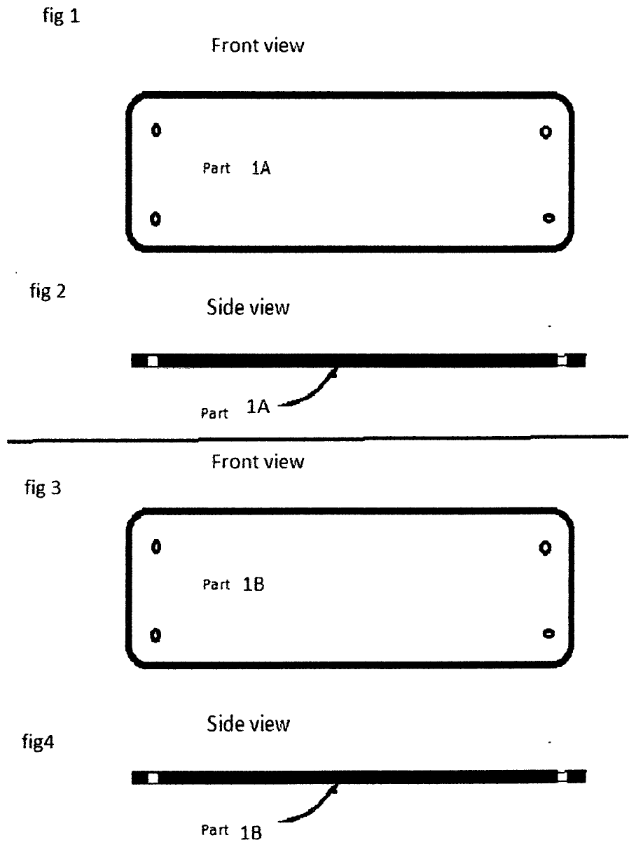

FIG. 1 is a
front view of part 1 A

FIG. 2 IS
a side view part 1 A

FIG. 3 is
front view of part 4 B

FIG. 4
side view of part 1 B

FIG. 5 is
side view of whole invention

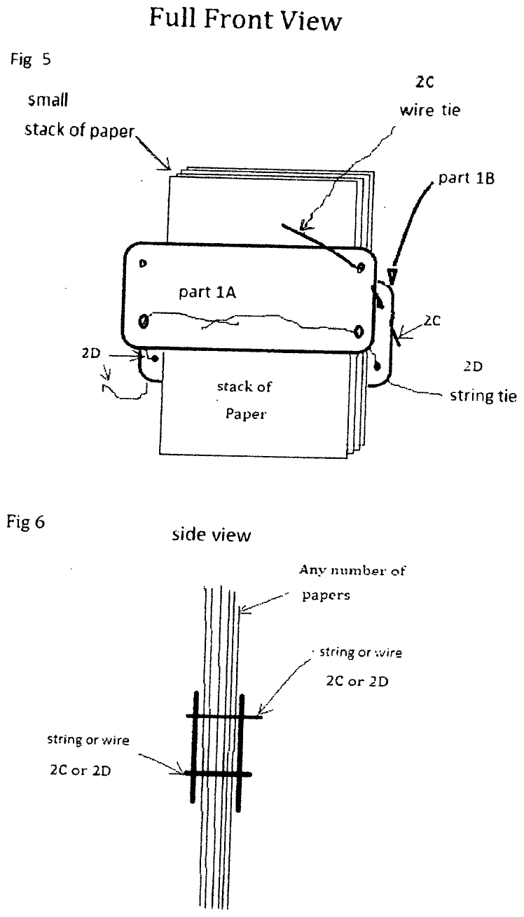

FIG. 6
top view of whole invention

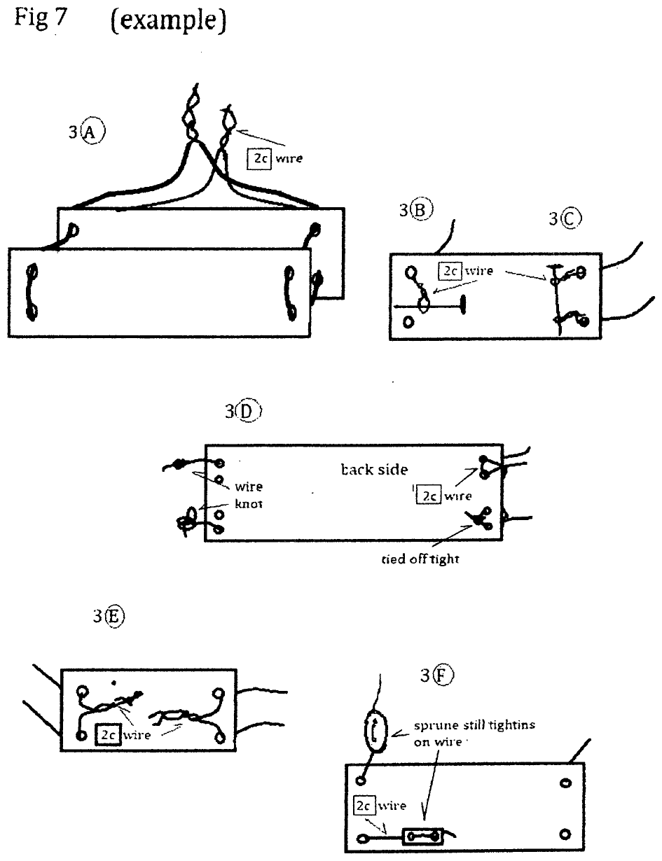

FIG. 7
{examples} of some type soft wire ties 3\textcircled{A} to 3\textcircled{F}

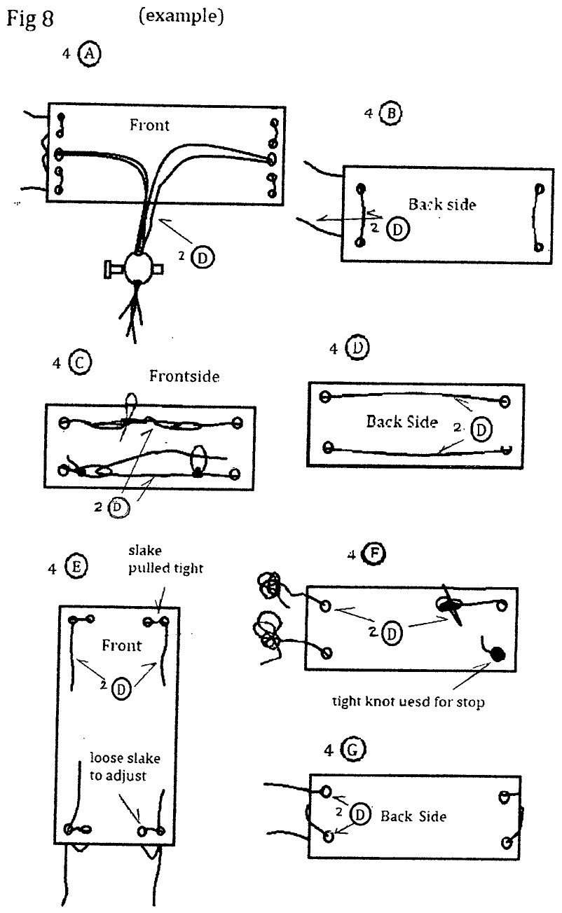

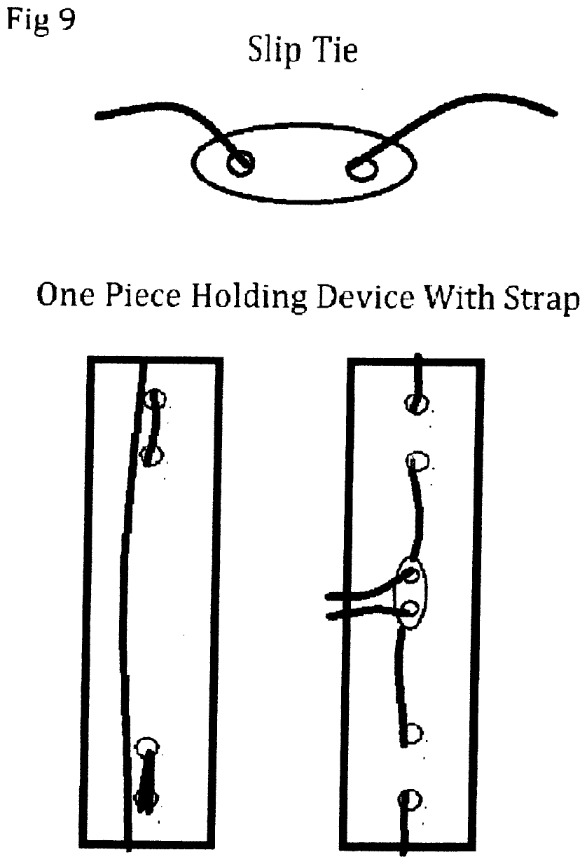

FIG. 8
{example} of some types of string ties 4\textcircled{A} to 4\textcircled{G}
FIG. 9
{example} of slip ties 5\textcircled{A} to 5\textcircled{G}

### DESCRIPTION

2 plates (1A, 1B) that open up to any amount governed only by length of wire (2c) string (2d). Were the wire (2c) or string can lengthen or shorten distance between plates (1A, 1B). Plates (1A, 1B) have holes in in end edges, so as to go around object.

To pull them together, such as folders paper books, ect. With slip ties (5H) or other tightening devices (5B-5H ect.) used at one or both ends to make adjustment easy
Wire or string (1A or 1B) can be totally fasten on one end (1B), so to adjust from the other end (1A) or adjust from both ends (1A and 1 B)

Some of the Ways to Build

Can be any size from 14 inches by 14 inches to 1 inch by 1 inch. Using any of many kinds of wire, rope, string, cable twine, elastic bands, etc. Out of Metal (steel, aluminum, brass, copper, etc.), Plastic (nylon vinyl, tile, PVC., neoprene, etc.), Wood (card board, particle board etc.), etc. Using any of many kinds of slip tie, tie slips, button, (sprung or spring device), slips (1, 2, 3 hole or more etc.) clips, or catch. Can be any (color or colors), (for or not for coding).

1. I Melvin Lee Bartoo claim my self as inventor of one and two piece holding device
The Invention is Intended to be used as a folder holder that fits in file cabinets. And can go around magazine, file folders, books, or just papers.
The first use is to be made 12 inches so to fit between bar and around files in many files cabinet types. Weather made width 2 hard plates used to squeeze file, books, papers, ect, together.
Or one plate with straps to hold papers in folder and files.
Smaller one can be made to fit around money or credit cards I claim the right to Patent and sell these devices
